(19) United States
(12) Patent Application Publication
(10) Pub. No.: US 2026/0214351 A1
(43) Pub. Date: Jul. 23, 2026

(54) INFORMATION PROCESSING APPARATUS, IMAGING APPARATUS, INFORMATION PROCESSING METHOD, AND INFORMATION PROCESSING PROGRAM

(71) Applicant: FUJIFILM Corporation, Tokyo (JP)

(72) Inventors: Yoshinori FURUTA, Saitama-shi (JP); Kazuya ODA, Saitama-shi (JP); Tomoyuki KAWAI, Saitama-shi (JP); Seiji TANAKA, Saitama-shi (JP)

(73) Assignee: FUJIFILM Corporation, Tokyo (JP)

(21) Appl. No.: 19/567,274

(22) Filed: Mar. 16, 2026

Related U.S. Application Data
(63) Continuation of application No. PCT/JP2024/014992, filed on Apr. 15, 2024.

(30) Foreign Application Priority Data
Sep. 28, 2023 (JP) 2023168348

(51) Int. Cl. H04N 25/626; H04N 25/11

(52) U.S. Cl. CPC H04N 25/626; H04N 25/11

(57) ABSTRACT

An information processing apparatus includes: an imaging element including plural pixels each including a photoelectric conversion unit that converts light collected by a microlens into an electric charge, the plural pixels include first pixels in each of which the microlens is shared with an adjacent pixel and second pixels different from the first pixels; and a processor that is configured to determine, based on a first pixel value of one of the first pixels and a second pixel value of one of the second pixels, whether abnormal light incident on the one of the first pixels is present.

### CROSS REFERENCE TO RELATED APPLICATION

This is a continuation of International Application No. PCT/JP2024/014992 filed on Apr. 15, 2024, and claims priority from Japanese Patent Application No. 2023-168348 filed on Sep. 28, 2023, the entire disclosures of which are incorporated herein by reference.

### BACKGROUND OF THE INVENTION

### 1. Field of the Invention

The disclosed technology relates to an information processing apparatus, an imaging apparatus, an information processing method, and a computer readable medium storing an information processing program.

### 2. Description of the Related Art

JP2014-165787A discloses an imaging element including pixels having one photoelectric conversion unit and one microlens and pixels having two photoelectric conversion units and one microlens.

JP2018-152829A discloses an image processing apparatus including an imaging element including a comparing unit that compares, based on image data generated by an imaging element including a light-receiving unit in which a plurality of unit pixels, each formed of a set of a plurality of photoelectric conversion elements, are arranged in a two-dimensional matrix shape and a microlens that is provided for each unit pixel and is laminated on a light-receiving surface of the unit pixel, output values of the plurality of photoelectric conversion elements for each unit pixel to detect an abnormal output, and an estimating unit that estimates an abnormality using the output values of the plurality of photoelectric conversion elements in the unit pixel in which the abnormal output is detected by the comparing unit.

WO2015/045829A discloses an imaging apparatus including an image sensor in which pixels are arranged in a two-dimensional shape, the pixels each having an on-chip microlens that is divided into a plurality of regions and forms a pupil image of an imaging optical system in the plurality of regions, and a reading unit that reads out signals converted into photoelectric signals for each of the plurality of divided regions, a signal intensity detection unit that detects a signal intensity of at least a peripheral portion of a signal of a center portion and a peripheral portion in the plurality of divided regions for each pixel read out by the reading unit, and a ghost detection unit that detects a ghost based on the signal intensity detected by the signal intensity detection unit.

### SUMMARY OF THE INVENTION

An information processing apparatus, an imaging apparatus, an information processing method, and a computer readable medium storing an information processing program according to one embodiment of the disclosed technology are as follows. It should be noted that components and the like corresponding to those in the embodiment described below are shown in parentheses, but the present disclosure is not limited thereto.
(1)
   An information processing apparatus that processes an output of an imaging element (imaging element 5) including a plurality of pixels (pixels 61) each including a photoelectric conversion unit (photoelectric conversion unit PD) that converts light collected by a microlens (microlens ML) into an electric charge, the plurality of pixels including first pixels (first phase difference detection pixel 61FA and second phase difference detection pixel 61FB) in which the microlens is shared with an adjacent pixel, and second pixels (pixel 61R, pixel 61G, pixel 61B) different from the first pixels, the information processing apparatus comprising: a processor (system control unit 11) that determines, based on a first pixel value of the first pixel and a second pixel value of the second pixel, whether abnormal light incident on the first pixel is present.
(2)
   The information processing apparatus according to (1), in which the second pixel is a pixel that has the microlens alone.
(3)
   The information processing apparatus according to (1) or (2), in which the processor determines, based on a comparison result between the first pixel value and the second pixel value, whether the abnormal light is present.
(4)
   The information processing apparatus according to (3), in which the processor determines, based on the comparison result and a threshold value (determination threshold value THC, determination threshold value THR, or determination threshold value THL), whether the abnormal light is present.
(5)
   The information processing apparatus according to (4), in which the comparison result is a ratio between the first pixel value and the second pixel value or a difference between the first pixel value and the second pixel value.
(6)
   The information processing apparatus according to (5), in which the processor determines that the abnormal light is present in a case where the comparison result is equal to or larger than the threshold value.
(7)
   The information processing apparatus according to any one of (4) to (6), in which the processor controls the threshold value.
(8)
   The information processing apparatus according to (7), in which the processor changes the threshold value based on a position of the first pixel that is a target for determining whether the abnormal light is present.
(9)
   The information processing apparatus according to (7) or (8), in which the processor changes the threshold value based on a condition of an imaging optical system disposed between the imaging element and a subject.
(10)
   The information processing apparatus according to (9), in which the condition includes at least one of an F number of a stop included in the imaging optical system or a focal length of the imaging optical system.
(11)
   The information processing apparatus according to any one of (1) to (10), wherein the first pixel includes a luminance filter (luminance filter LF), the second pixel includes a color filter (color filter CF), the plurality of pixels include a plurality of types of the second pixels having different types of the color filter, and the processor determines, based on the first pixel value of the first pixel and a second pixel value of any of the plurality of types of the second pixels, whether the abnormal light incident on the first pixel is present.
(12)
   The information processing apparatus according to any one of (1) to (10), wherein the first pixel and the second pixel include a color filter (color filter CF), the plurality of pixels include a plurality of types of the first pixels having different types of the color filter and a plurality of types of the second pixels having different types of the color filter, and the processor determines, based on a first pixel value of the first pixel including a first type of the color filter and a second pixel value of the second pixel including the first type of the color filter, whether the abnormal light incident on the first pixel is present.
(13)
   The information processing apparatus according to any one of (1) to (12), wherein the processor performs a focus detection process based on a pixel value of the first pixel.
(14)
   The information processing apparatus according to (13), in which the processor performs, in a case where it is determined that the first pixel on which the abnormal light is incident is present, the focus detection process based on pixel values of the first pixels excluding at least the first pixel.
(15)
   The information processing apparatus according to (14), wherein the processor performs, in a case where it is determined that the first pixel on which the abnormal light is incident is present, the focus detection process based on pixel values of the first pixels excluding the first pixel and the first pixels around the first pixel.
(16)
   The information processing apparatus according to any one of (1) to (15), in which the processor further uses a comparison result of pixel values of a plurality of the first pixels that include a plurality of the photoelectric conversion units in which the microlens is shared to determine whether the abnormal light is present.
(17)
   The information processing apparatus according to any one of (1) to (16), in which the first pixels are pixels in which the microlens is shared between two adjacent first pixels.
(18)
   An imaging apparatus comprising: the information processing apparatus according to any one of claims (1) to (17); and the imaging element.
(19)
   An information processing method for processing an output of an imaging element including a plurality of pixels each including a photoelectric conversion unit that converts light collected by a microlens into an electric charge, the plurality of pixels including first pixels in which the microlens is shared with an adjacent pixel and second pixels different from the first pixels, the information processing method comprising: a step of determining, based on a first pixel value of the first pixel and a second pixel value of the second pixel, whether abnormal light incident on the first pixel is present.
(20)
   A computer readable medium storing information processing program for processing an output of an imaging element including a plurality of pixels each including a photoelectric conversion unit that converts light collected by a microlens into an electric charge, the plurality of pixels including first pixels in which the microlens is shared with an adjacent pixel and second pixels different from the first pixels, the information processing program causing a processor to execute:
   a step of determining, based on a first pixel value of the first pixel and a second pixel value of the second pixel, whether abnormal light incident on the first pixel is present.

### BRIEF DESCRIPTION OF THE DRAWINGS

FIG. 1 is a diagram showing a schematic configuration of a digital camera 100 that is an embodiment of an imaging apparatus according to the disclosed technology.

FIG. 2 is a schematic plan view showing a schematic configuration of an imaging element 5 shown in FIG. 1.

FIG. 3 is a schematic diagram for describing an angle of light incident on a pixel 61 in a state of being viewed in a column direction Y.

FIG. 4 is a schematic diagram showing a partially enlarged imaging surface 60 of the imaging element 5 shown in FIG. 2.

FIG. 5 is a schematic cross-sectional view of a range A1 shown in FIG. 4.

FIG. 6 is a schematic cross-sectional view of a range A2 shown in FIG. 4.

FIG. 7 is a diagram showing output characteristics of a pixel 61G, the first phase difference detection pixel 61FA, and a second phase difference detection pixel 61FB.

FIG. 8 is a diagram for describing a first modification example of the imaging element 5, and is a schematic cross-sectional view showing the range A2 of FIG. 4.

FIG. 9 is a diagram showing output characteristics of the pixel 61G, the first phase difference detection pixel 61FA, and the second phase difference detection pixel 61FB in the imaging element 5 of the modification example shown in FIG. 8.

FIG. 10 is a diagram for describing a second modification example of the imaging element 5, and is a diagram corresponding to FIG. 4.

FIG. 11 is a schematic cross-sectional view of a range A3 of FIG. 10.

FIG. 12 is a schematic cross-sectional view of a range A4 of FIG. 10.

FIG. 13 is a diagram showing a third modification example of the imaging element 5, and is a diagram corresponding to FIG. 4.

FIG. 14 is a diagram showing a fourth modification example of the imaging element 5, and is a diagram corresponding to FIG. 4.

FIG. 15 is a diagram showing an exterior of a smartphone 200.

FIG. 16 is a block diagram showing a configuration of the smartphone 200 shown in FIG. 15.

### DESCRIPTION OF THE PREFERRED EMBODIMENTS

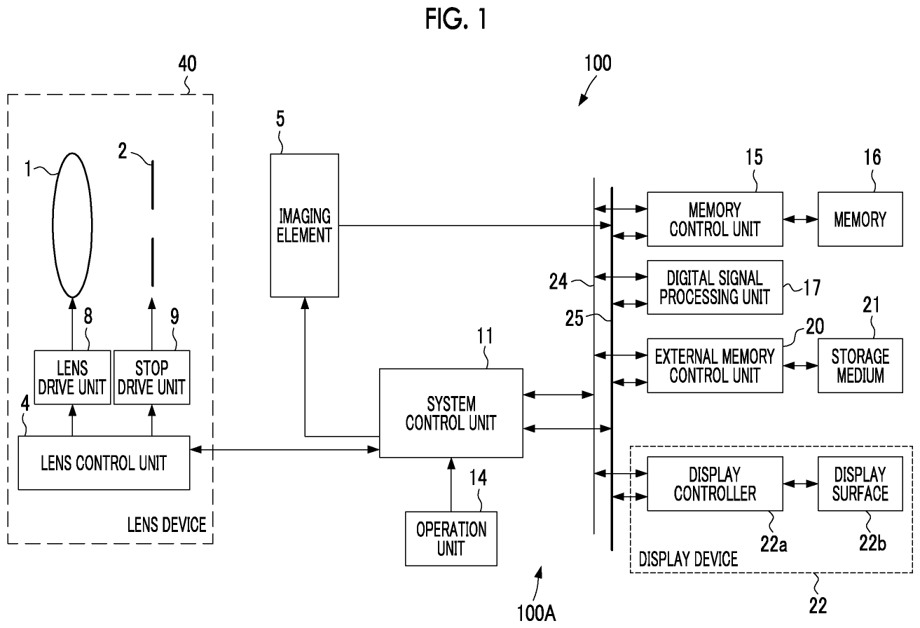

FIG. 1 is a diagram showing a schematic configuration of a digital camera 100 that is an embodiment of an imaging apparatus according to the disclosed technology. The digital camera 100 shown in FIG. 1 comprises a lens device 40 including an imaging lens 1, a stop 2, a lens drive unit 8 that drives the imaging lens 1, a stop drive unit 9 that drives the stop 2, and a lens control unit 4 that controls the lens drive unit 8 and the stop drive unit 9, and a body part 100A.

The body part 100A comprises an imaging element 5, a system control unit 11 that manages and controls the entire electric control system of the digital camera 100, an operation unit 14, a display device 22, a memory 16 including a random access memory (RAM), a read only memory (ROM), and the like, and a memory control unit 15 that controls data storage in the memory 16 and data readout from the memory 16, a digital signal processing unit 17, and an external memory control unit 20 that controls data storage in a storage medium 21 and data readout from the storage medium 21.

The lens device 40 may be attachable to and detachable from the body part 100A or may be integrated with the body part 100A. The imaging lens 1 includes a focus lens.

The focus lens is a lens for adjusting a focal point of an imaging optical system including the imaging lens 1 and the stop 2, and is composed of a single lens or of a plurality of lenses. By moving the focus lens in the optical axis direction, a position of a principal point of the focus lens (hereinafter, also referred to as a focus lens position) changes along the optical axis direction, and a focal position on a subject side is changed. A liquid lens of which a position of a principal point in the optical axis direction can be changed by electrical control may be used as the focus lens.

The lens control unit 4 of the lens device 40 controls the lens drive unit 8 based on a lens driving signal transmitted from the system control unit 11 to change the focus lens position. The lens control unit 4 of the lens device 40 changes an amount of opening (F number (F value) of the stop 2 by controlling the stop drive unit 9 based on a driving control signal transmitted from the system control unit 11.

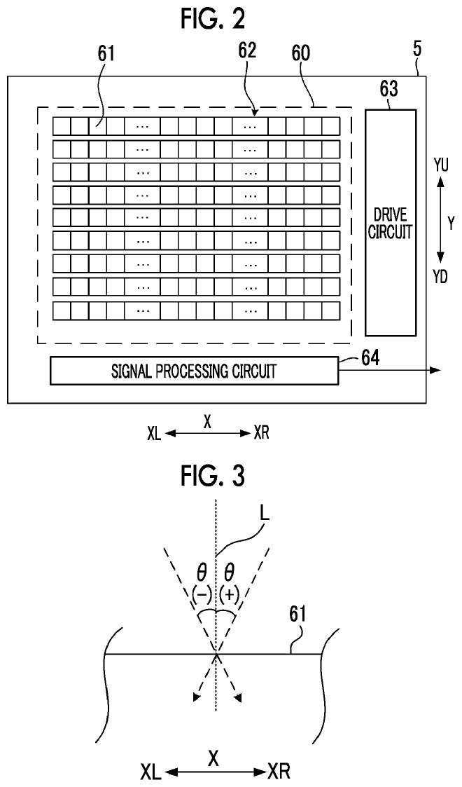

The imaging element 5 images the subject through the imaging optical system provided between the imaging element 5 and the subject. The imaging element 5 includes an imaging surface 60 (refer to FIG. 2) on which a plurality of pixels are two-dimensionally arranged, converts a subject image formed on the imaging surface 60 by the imaging optical system into image signals by the plurality of pixels, and outputs the image signals. An output of the pixel included in the imaging element 5 is referred to as a pixel value or a pixel signal, and a set of the pixel values or the pixel signals is referred to as an image signal.

For example, a complementary metal-oxide semiconductor (CMOS) image sensor or a charge coupled device (CCD) image sensor is used as the imaging element 5. Hereinafter, an example in which the imaging element 5 is a CMOS image sensor will be described.

The system control unit 11 manages and controls the entire digital camera 100 and has a hardware structure corresponding to various processors that perform processing by executing programs. The programs (including an information processing program) executed by the system control unit 11 are stored in the ROM (non-transitory storage medium) of the memory 16. The memory 16 and the system control unit 11 constitute an information processing apparatus that processes the output of the imaging element 5.

Examples of the various processors include a central processing unit (CPU) that is a general-purpose processor performing various types of processing by executing a program, a programmable logic device (PLD) such as a field programmable gate array (FPGA) that is a processor of which a circuit configuration can be changed after manufacture, or a dedicated electric circuit such as an application specific integrated circuit (ASIC) that is a processor having a circuit configuration dedicatedly designed to execute specific processing. More specifically, a structure of these various processors is an electric circuit in which circuit elements such as semiconductor devices are combined.

The system control unit 11 may be configured with one of the various processors or may be configured with a combination of two or more processors of the same type or of different types (for example, a combination of a plurality of FPGAs or a combination of a CPU and an FPGA).

The system control unit 11 drives the imaging element 5 and the lens device 40 and outputs the subject image captured through the imaging optical system of the lens device 40 as the image signal. By processing the image signal output from the imaging element 5 via the digital signal processing unit 17, captured image data that is data suitable for display on the display device 22 or is data suitable for storage in the storage medium 21 is generated.

An instruction signal from a user is input to the system control unit 11 through the operation unit 14. The operation unit 14 includes a touch panel integrated with a display surface 22b, and various buttons and the like.

The display device 22 comprises the display surface 22b configured with an organic electro luminescence (EL) panel, a liquid crystal panel, or the like, and a display controller 22a that controls display on the display surface 22b.

The memory control unit 15, the digital signal processing unit 17, the external memory control unit 20, and the display controller 22a are connected to each other through a control bus 24 and through a data bus 25 and are controlled in accordance with instructions from the system control unit 11.

FIG. 2 is a schematic plan view showing a schematic configuration of the imaging element 5 shown in FIG. 1. The imaging element 5 comprises an imaging surface 60 on which a plurality of pixel rows 62, which include a plurality of pixels 61 arranged in the row direction X, are arranged in the column direction Y intersecting the row direction X, a drive circuit 63 which drives the pixels 61 which are arranged on the imaging surface 60, and a signal processing circuit 64 which processes the pixel signal read out from each of the pixels 61 of the pixel row 62 arranged on the imaging surface 60 into a signal line. In the example of FIG. 2, the row direction X and the column direction Y are orthogonal to each other. One of the row direction X is referred to as a right direction XR, and the other of the row direction X is referred to as a left direction XL. One of the column direction Y is referred to as an upward direction YU, and the other of the column direction Y is referred to as a downward direction YD.

FIG. 3 is a schematic diagram for describing an angle of light incident on the pixel 61 in a state of being viewed in the column direction Y. A straight line L in FIG. 3 indicates a line parallel to an optical axis of the imaging optical system or a line perpendicular to the imaging surface 60. Hereinafter, an angle between a ray (indicated by a broken line arrow in FIG. 3) incident on the pixel 61 and the straight line L is defined as an incidence angle θ of the light on the pixel 61. The incidence angle θ is a positive value of an angle between light incident obliquely from a right direction XR side with respect to the straight line L and the straight line L, and is a negative value of an angle between light incident obliquely from a left direction XL side with respect to the straight line L and the straight line L. In end parts of the imaging surface 60 in the right direction XR and the left direction XL, an absolute value of the incidence angle θ is larger than that in a center part of the imaging surface 60 (near a location intersecting the optical axis of the imaging optical system). In other words, in a case where a position of the pixel 61 at an intersection with the optical axis on the imaging surface 60 is defined as a reference position, the incidence angle θ of the pixel 61 has a larger absolute value as the position of the pixel 61 is farther from the reference position in the row direction X.

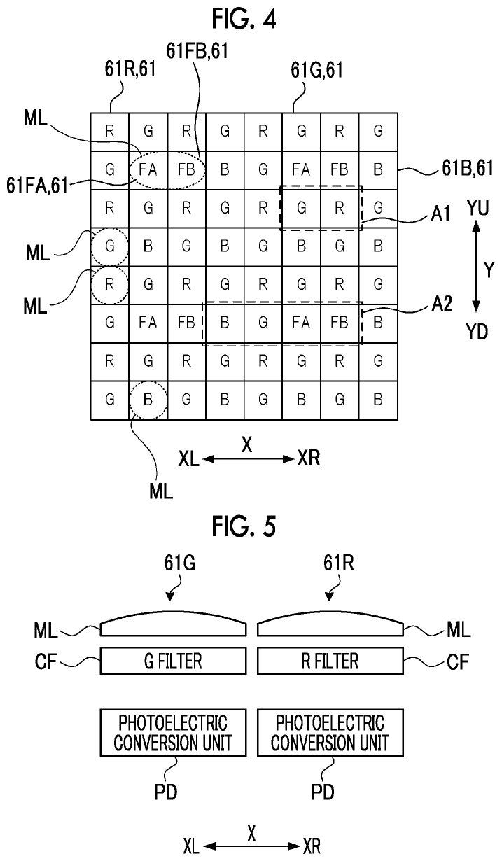

FIG. 4 is a schematic diagram showing a partially enlarged imaging surface 60 of the imaging element 5 shown in FIG. 2. The plurality of pixels 61 disposed on the imaging surface 60 include pixels each corresponding to a plurality (three in the present embodiment) of wavelength ranges. Specifically, the imaging surface 60 is provided with a pixel 61R corresponding to a wavelength range of red light (a block with a character “R” in FIG. 4), a pixel 61G corresponding to a wavelength range of green light (a block with a character “G” in FIG. 4), a pixel 61B corresponding to a wavelength range of blue light (a block with a character “B” in FIG. 4), a first phase difference detection pixel 61FA corresponding to the wavelength range of the green light (a block with a character “FA” in FIG. 4), and a second phase difference detection pixel 61FB corresponding to the wavelength range of the green light (a block with a character “FB” in FIG. 4). Each pixel 61 provided on the imaging surface 60 receives light in the corresponding wavelength range and outputs a pixel signal corresponding to the amount of the light.

On the imaging surface 60, the pixel 61R, the pixel 61G, and the pixel 61B are arranged based on a Bayer pattern. That is, on the imaging surface 60, an RG pixel row in which the pixel 61R and the pixel 61G are alternately arranged in the row direction X and a GB pixel row in which the pixel 61G and the pixel 61B are alternately arranged in the row direction X are alternately arranged in the column direction Y. An arrangement pattern of the pixels 61 disposed on the imaging surface 60 is not limited to the Bayer pattern, and various patterns can be adopted.

In some of the GB pixel rows in the plurality of pixel rows, a part of the pixels 61B are replaced with the first phase difference detection pixel 61FA, and a part of the pixels 61G are replaced with the second phase difference detection pixel 61FB, and the first phase difference detection pixel 61FA and the second phase difference detection pixel 61FB are adjacent to each other. In some of the GB pixel rows, a plurality of phase difference detection pairs, each including a first phase difference detection pixel 61FA and an adjacent second phase difference detection pixel 61FB, are arranged in the row direction X at intervals. Some of the GB pixel row may be configured of only the phase difference detection pair. It should be noted that the phase difference detection pair may be provided in the RG pixel row. In this case, the adjacent pixels 61G and 61R may be replaced with the phase difference detection pair.

The system control unit 11 performs a focus detection process based on the pixel value of the first phase difference detection pixel 61FA and the pixel value of the second phase difference detection pixel 61FB. Specifically, the system control unit 11 performs a correlation operation between a pixel signal group output from the first phase difference detection pixel 61FA included in the same pixel row and a pixel signal group output from the second phase difference detection pixel 61FB to detect a phase difference, and performs a focus detection process of deriving a focus lens position required for focusing on a target subject based on the phase difference.

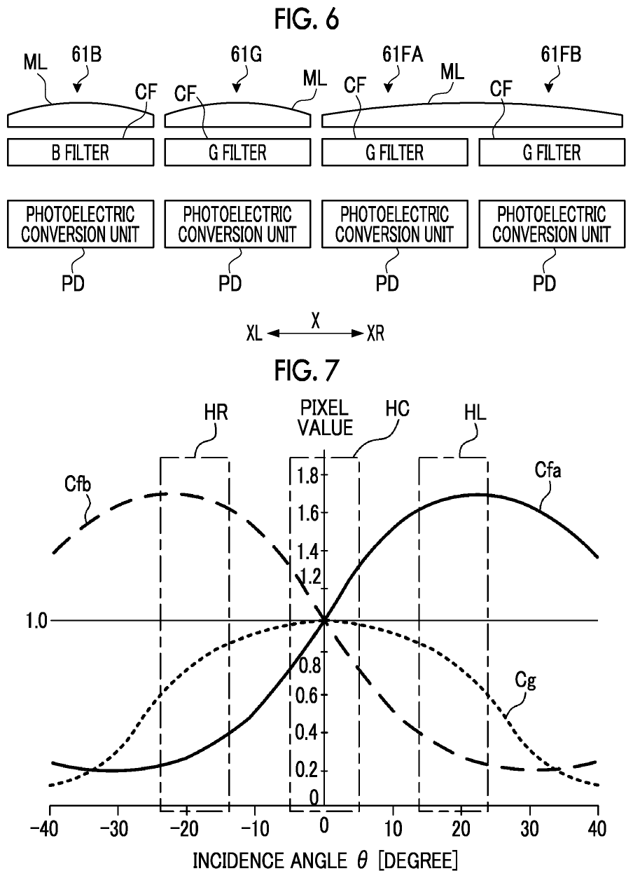

FIG. 5 is a schematic cross-sectional view of a range A1 shown in FIG. 4. FIG. 6 is a schematic cross-sectional view of a range A2 shown in FIG. 4. As shown in FIGS. 5 and 6, each pixel 61 provided on the imaging surface 60 includes a microlens ML that collects light from a subject, a photoelectric conversion unit PD that converts the light collected by the microlens ML into an electric charge, and a color filter CF that transmits light of a specific wavelength range provided between the photoelectric conversion unit PD and the microlens ML.

Although not shown, a reading circuit that converts the electric charge generated by the photoelectric conversion unit PD into a pixel value and reads out the pixel value is provided in the pixel 61. In addition, a light shielding film that defines a light-receiving area of the photoelectric conversion unit PD, a light shielding film that shields the above-described reading circuit disposed close to the photoelectric conversion unit PD, or the like is provided between the photoelectric conversion unit PD and the color filter CF. The photoelectric conversion unit PD is a photodiode formed in a semiconductor substrate such as silicon, but may be configured by an organic material film or the like disposed above the semiconductor substrate.

The color filter CF (referred to as an R filter in FIG. 5) included in the pixel 61R transmits the red light, the color filter CF (referred to as a G filter in FIGS. 5 and 6) included in the pixel 61G transmits the green light, and the color filter CF (referred to as a B filter in FIG. 6) included in the pixel 61B transmits the blue light. The color filter CF included in each of the first phase difference detection pixel 61FA and the second phase difference detection pixel 61FB is a G filter that transmits green light.

As described above, on the imaging surface 60, a plurality of types (three types in the present embodiment) of pixels 61 (the pixel 61R, the pixel 61G, and the pixel 61B) having different types of the color filter CF and a phase difference detection pair of the first phase difference detection pixel 61FA and the second phase difference detection pixel 61FB including the color filter CF of the same type as the pixel 61G are disposed. In a case where red, green, and blue are spectrally divided by the structure of the photoelectric conversion unit PD itself, the color filter CF can be omitted.

The microlens ML is shared between the first phase difference detection pixel 61FA and the adjacent second phase difference detection pixel 61FB. That is, the microlens ML included in the first phase difference detection pixel 61FA and the microlens ML included in the adjacent second phase difference detection pixel 61FB are the same. As partially shown in FIG. 4, a planar shape of the microlens ML provided in the phase difference detection pair is an elliptical shape in which a major axis extends in the row direction X. The microlens ML having the elliptical shape is provided above the two photoelectric conversion units PD arranged in the row direction X in the phase difference detection pair, spanning the two photoelectric conversion units PD. On the other hand, the pixel 61R, the pixel 61G, and the pixel 61B each include the microlens ML alone, and the microlens ML is not shared with other pixels 61. It can also be said that the phase difference detection pair shares the microlens ML. The first phase difference detection pixel 61FA and the second phase difference detection pixel 61FB each constitute the first pixel. The pixel 61R, the pixel 61G, and the pixel 61B each constitute the second pixel different from the first pixel. It can also be said that the second pixel has optical characteristics different from those of the first pixel.

FIG. 7 is a diagram showing output characteristics of the pixel 61G, the first phase difference detection pixel 61FA, and the second phase difference detection pixel 61FB. A horizontal axis in FIG. 7 indicates the incidence angle θ of the light on the pixel 61, and a vertical axis indicates the pixel value output from the pixel 61. The pixel value indicates a value standardized with the pixel value of the pixel 61G at the incidence angle θ of 0 degrees as a reference (=1). A characteristic Cfa in FIG. 7 indicates the output characteristics of the first phase difference detection pixel 61FA. A characteristic Cfb in FIG. 7 indicates the output characteristics of the second phase difference detection pixel 61FB. A characteristic Cg in FIG. 7 indicates the output characteristics of the pixel 61G.

As shown in FIG. 7, the output characteristics of the pixel 61G are such that the pixel value is maximized at the incidence angle θ of 0 degrees, and the pixel value gradually decreases as the absolute value of the incidence angle θ increases. The output characteristics of the first phase difference detection pixel 61FA are such that the pixel value is larger in a range where the incidence angle θ is positive than in a range where the incidence angle θ is negative, and the pixel value is maximized at the incidence angle θ of 23 degrees. In addition, the output characteristics of the first phase difference detection pixel 61FA are larger than the maximum value of the pixel value of the pixel 61G in a range where the incidence angle θ is positive.

The characteristic Cfb is obtained by inverting the characteristic Cfa with the vertical axis as a boundary. The output characteristics of the second phase difference detection pixel 61FB are such that the pixel value is larger in a range where the incidence angle θ is negative than in a range where the incidence angle θ is positive, and the pixel value is maximized at the incidence angle θ of −23 degrees. In addition, the output characteristics of the second phase difference detection pixel 61FB are larger than the maximum value of the pixel value of the pixel 61G in a range where the incidence angle θ is negative.

It should be noted that, although not shown, the output characteristics of the pixel 61R and the output characteristics of the pixel 61B have a shape that is symmetric left and right with respect to the vertical axis, as in the characteristic Cg, the pixel value is maximized at the incidence angle θ of 0 degrees, and the pixel value gradually decreases as the absolute value of the incidence angle θ increases.

A range HC shown in FIG. 7 indicates a range of the incidence angle θ (hereinafter, also referred to as an incidence angle range) that can be taken by the light incident on the pixel 61 located at a center part of the imaging surface 60 in the row direction X. A range HR shown in FIG. 7 indicates an incidence angle range that can be taken by the light incident on the pixel 61 located at an end part of the imaging surface 60 in the right direction XR in the row direction X. A range HL shown in FIG. 7 indicates an incidence angle range that can be taken by the light incident on the pixel 61 located at an end part of the imaging surface 60 in the left direction XL in the row direction X.

A width of each of the range HC, the range HR, and the range HL fluctuates depending on an opening amount (F number) of the stop. For example, in a case where the opening amount is large, the widths of the range HC, the range HR, and the range HL are large, and in a case where the opening amount is small, the widths of the range HC, the range HR, and the range HL are small. In addition, the widths of the range HC, the range HR, and the range HL also fluctuate depending on a type of the lens device 40 and a focal length. For the range HR and the range HL, respective center positions of widths thereof can also change depending on a combination of the F number and the focal length. The F number and the focal length of the lens device 40 are each one of imaging conditions of the imaging optical system.

As shown in the range HC, the range HR, and the range HL of FIG. 7, the incidence angle range of the light incident on the pixel 61 fluctuates depending on the imaging conditions, but is determined by a position of the pixel 61 on the imaging surface 60. In the digital camera 100, a phenomenon called ghost or flare may occur. Such a phenomenon may occur in a case where light having an incidence angle θ with a large absolute value outside a range of the incidence angle θ of the light assumed to be incident on the imaging surface 60 (a range from a left end of the range HR to a right end of the range HL in FIG. 7) (for example, light having an incidence angle θ of ±25 degrees or ±30 degrees) is incident on the pixel 61. Light that causes such a ghost or a flare is referred to as abnormal light.

In the pixel 61 disposed at a position where the light of the range HC is incident, a ratio of the pixel value of the first phase difference detection pixel 61FA to the pixel value of the pixel 61G and a ratio of the pixel value of the second phase difference detection pixel 61FB to the pixel value of the pixel 61G are each approximately 1.3 times (referred to as a maximum value MC) at maximum. In a case where abnormal light having an incidence angle θ of 30 degrees is incident on the first phase difference detection pixel 61FA disposed at a position where the light of the range HC is incident, the ratio of the pixel value of the first phase difference detection pixel 61FA to the pixel value of the pixel 61G is sufficiently larger than the maximum value MC. In addition, in a case where abnormal light having an incidence angle θ of −30 degrees is incident on the second phase difference detection pixel 61FB disposed at a position where the light of the range HC is incident, the ratio of the pixel value of the second phase difference detection pixel 61FB to the pixel value of the pixel 61G is sufficiently larger than the maximum value MC. Therefore, by monitoring the ratio, it is possible to determine whether the abnormal light incident on the first phase difference detection pixel 61FA and the second phase difference detection pixel 61FB disposed at the position where the light of the range HC is incident is present.

The system control unit 11 sets, for example, a value (for example, 1.5 times) larger than the maximum value MC as a determination threshold value THC of the abnormal light for the pixel 61 at the position where the light of the range HC is incident. Then, the system control unit 11 determines whether or not the ratio of the pixel value of the first phase difference detection pixel 61FA to the pixel value of the pixel 61G is equal to or larger than the determination threshold value THC for the first phase difference detection pixel 61FA and the pixel 61G located at the position where the light of the range HC is incident and in the vicinity thereof, and determines that the abnormal light incident on the first phase difference detection pixel 61FA is present in a case where the determination result is YES. In addition, the system control unit 11 determines whether or not the ratio of the pixel value of the second phase difference detection pixel 61FB to the pixel value of the pixel 61G is equal to or larger than the determination threshold value THC for the second phase difference detection pixel 61FB and the pixel 61G located at the position where the light of the range HC is incident and in the vicinity thereof, and determines that the abnormal light incident on the second phase difference detection pixel 61FB is present in a case where the determination result is YES.

In the range HR where the incidence angle of the light is large, the ratio of the pixel value of the pixel 61G to the pixel value of the second phase difference detection pixel 61FB does not change significantly as compared with the outside of the negative side of the range HR, but the ratio of the pixel value of the pixel 61G to the pixel value of the first phase difference detection pixel 61FA changes significantly. For example, in a case where abnormal light having an incidence angle θ of −30 degrees is incident on the first phase difference detection pixel 61FA disposed at a position where the light of the range HR is incident, the ratio of the pixel value of the first phase difference detection pixel 61FA to the pixel value of the pixel 61G is sufficiently larger than the ratio that can be taken in the range HR.

For example, a maximum value MR of the ratio of the pixel value of the first phase difference detection pixel 61FA to the pixel value of the pixel 61G in a case where the light of the range HR is incident is set to 0.4 times. The system control unit 11 sets, for the pixel 61 at the position where the light of the range HR is incident, a value (for example, 0.6 times) larger than the maximum value MR as a determination threshold value THR of the abnormal light. Then, the system control unit 11 determines whether or not the ratio of the pixel value of the first phase difference detection pixel 61FA to the pixel value of the pixel 61G is equal to or larger than the determination threshold value THR for the first phase difference detection pixel 61FA and the pixel 61G located at the position where the light of the range HR is incident and in the vicinity thereof, and determines that the abnormal light incident on the first phase difference detection pixel 61FA is present in a case where the determination result is YES.

Similarly, in the range HL, the ratio of the pixel value of the pixel 61G to the pixel value of the first phase difference detection pixel 61FA does not change significantly as compared with the outside of the positive side of the range HL, but the ratio of the pixel value of the pixel 61G to the pixel value of the second phase difference detection pixel 61FB changes significantly. For example, in a case where abnormal light having an incidence angle θ of 30 degrees is incident on the second phase difference detection pixel 61FB disposed at a position where the light of the range HL is incident, the ratio of the pixel value of the second phase difference detection pixel 61FB to the pixel value of the pixel 61G is sufficiently larger than the ratio that can be taken in the range HL.

For example, a maximum value ML of the ratio of the pixel value of the second phase difference detection pixel 61FB to the pixel value of the pixel 61G in a case where the light of the range HL is incident is set to 0.4 times. The system control unit 11 sets, for the pixel 61 at the position where the light of the range HL is incident, a value (for example, 0.6 times) larger than the maximum value ML as a determination threshold value THL of the abnormal light. Then, the system control unit 11 determines whether or not the ratio of the pixel value of the second phase difference detection pixel 61FB to the pixel value of the pixel 61G is equal to or larger than the determination threshold value THL for the second phase difference detection pixel 61FB and the pixel 61G located at the position where the light of the range HL is incident and in the vicinity thereof, and determines that the abnormal light incident on the second phase difference detection pixel 61FB is present in a case where the determination result is YES.

It should be noted that, for the pixel 61 at the position where the light of the incidence angle range between the range HC and the range HR is incident and the pixel 61 at the position where the light of the incidence angle range between the range HC and the range HL is incident, a ratio of the pixel values of the first phase difference detection pixel 61FA, the second phase difference detection pixel 61FB, and the pixel 61G maintains a relationship substantially the same as that in the range HC. Therefore, it is possible to determine whether the abnormal light is present by the same method as in the range HC. However, the determination threshold value for determining whether the abnormal light is present needs to be larger than the determination threshold value THC.

The maximum value MC, the maximum value MR, and the maximum value ML change depending on a combination of the F number and the focal length. Therefore, it is preferable that the determination threshold value THC, the determination threshold value THR, and the determination threshold value THL are changed depending on the combination of the F number and the focal length. That is, it is preferable that the system control unit 11 sets the determination threshold value THC, the determination threshold value THR, and the determination threshold value THL based on the imaging conditions each time the imaging conditions change, and determines whether the abnormal light is present by using the set determination threshold values.

Here, a method of determining whether the abnormal light is present by using the ratio of the two pixel values has been described, but the same determination can be made by using the difference between the two pixel values. The system control unit 11 sets, for example, a determination threshold value larger than a maximum value that can be taken by the difference (absolute value) between the pixel values of the first phase difference detection pixel 61FA and the pixel 61G in a case where the light of the range HC is incident. The system control unit 11 determines that the abnormal light incident on the first phase difference detection pixel 61FA is present in a case where a value obtained by subtracting the pixel value of the pixel 61G from the pixel value of the first phase difference detection pixel 61FA is equal to or larger than the determination threshold value for the pixel 61 at the position where the light of the range HC is incident, and determines that the abnormal light incident on the second phase difference detection pixel 61FB is present in a case where a value obtained by subtracting the pixel value of the pixel 61G from the pixel value of the second phase difference detection pixel 61FB is equal to or larger than the determination threshold value for the pixel 61 at the position where the light of the range HC is incident.

In addition, the system control unit 11 sets, for example, a determination threshold value smaller than a minimum value that can be taken by the difference (absolute value) between the pixel values of the first phase difference detection pixel 61FA and the pixel 61G in a case where the light of the range HR is incident. The system control unit 11 determines that the abnormal light incident on the first phase difference detection pixel 61FA is present in a case where a value obtained by subtracting the pixel value of the first phase difference detection pixel 61FA from the pixel value of the pixel 61G is equal to or smaller than the determination threshold value for the pixel 61 at the position where the light of the range HR is incident.

In addition, the system control unit 11 sets, for example, a determination threshold value smaller than a minimum value that can be taken by the difference (absolute value) between the pixel values of the second phase difference detection pixel 61FB and the pixel 61G in a case where the light of the range HL is incident. The system control unit 11 determines that the abnormal light incident on the second phase difference detection pixel 61FB is present in a case where a value obtained by subtracting the pixel value of the second phase difference detection pixel 61FB from the pixel value of the pixel 61G is equal to or smaller than the determination threshold value for the pixel 61 at the position where the light of the range HL is incident.

As described above, the system control unit 11 determines whether or not the abnormal light incident on the first phase difference detection pixel 61FA is present based on the pixel value of the first phase difference detection pixel 61FA and the pixel value of the pixel 61G (for example, any of the pixels 61G at the closest position) in the vicinity of the first phase difference detection pixel 61FA for the first phase difference detection pixel 61FA located in a region (pixel position where the incidence angle θ is incident between the range HR and the range HL) where the incidence angle θ of the light is small. More specifically, the system control unit 11 determines whether the abnormal light incident on the first phase difference detection pixel 61FA is present based on the comparison result (the above-described ratio or difference) between the two pixel values and the determination threshold value.

In addition, the system control unit 11 determines whether the abnormal light incident on the second phase difference detection pixel 61FB is present based on the pixel value of the second phase difference detection pixel 61FB and the pixel value of the pixel 61G (for example, any of the pixels 61G at the closest position) in the vicinity of the second phase difference detection pixel 61FB for the second phase difference detection pixel 61FB located in the region where the incidence angle θ of the light is small. More specifically, the system control unit 11 determines whether or not the abnormal light incident on the second phase difference detection pixel 61FB is present based on the comparison result (the above-described ratio or difference) between the two pixel values and the determination threshold value.

In addition, the system control unit 11 determines whether or not the abnormal light incident on the first phase difference detection pixel 61FA is present based on the pixel value of the first phase difference detection pixel 61FA and the pixel value of the pixel 61G (for example, any of the pixels 61G at the closest position) in the vicinity of the first phase difference detection pixel 61FA for the first phase difference detection pixel 61FA located in a region (pixel position where the light of the range HR is incident) where the incidence angle θ of the light is large. More specifically, the system control unit 11 determines whether the abnormal light incident on the first phase difference detection pixel 61FA is present based on the comparison result (the above-described ratio or difference) between the two pixel values and the determination threshold value.

In addition, the system control unit 11 determines whether or not the abnormal light incident on the second phase difference detection pixel 61FB is present based on the pixel value of the second phase difference detection pixel 61FB and the pixel value of the pixel 61G (for example, any of the pixels 61G at the closest position) in the vicinity of the second phase difference detection pixel 61FB for the second phase difference detection pixel 61FB located in the region (pixel position where the light of the range HL is incident) where the incidence angle θ of the light is large. More specifically, the system control unit 11 determines whether or not the abnormal light incident on the second phase difference detection pixel 61FB is present based on the comparison result (the above-described ratio or difference) between the two pixel values and the determination threshold value.

As described above, with the digital camera 100, it is possible to determine whether or not the abnormal light incident on the first phase difference detection pixel 61FA and the second phase difference detection pixel 61FB is present, thereby improving the detection accuracy of the phase difference and performing the focusing control with high accuracy.

For example, in a case where it is determined that the first phase difference detection pixel 61FA or the second phase difference detection pixel 61FB on which the abnormal light is incident is present, the system control unit 11 detects the phase difference based on the pixel value of the other phase difference detection pair from which at least the phase difference detection pair including the first phase difference detection pixel 61FA or the second phase difference detection pixel 61FB is excluded. In this way, the phase difference can be detected with high accuracy.

In addition, with the digital camera 100, the system control unit 11 controls the determination threshold value for determining whether the abnormal light is present to any of a plurality of values. Specifically, the system control unit 11 changes the determination threshold value based on the position of the first phase difference detection pixel 61FA or the second phase difference detection pixel 61FB that is a target for determining whether the abnormal light is present on the imaging surface 60. As a result, it is possible to improve the accuracy of determining whether the abnormal light is present as compared with a configuration in which the determination threshold value is fixed to one in the entire imaging surface 60. In addition, the system control unit 11 changes the determination threshold value for determining whether the abnormal light is present based on a condition of the imaging optical system. As a result, it is possible to improve the accuracy of determining whether the abnormal light is present.

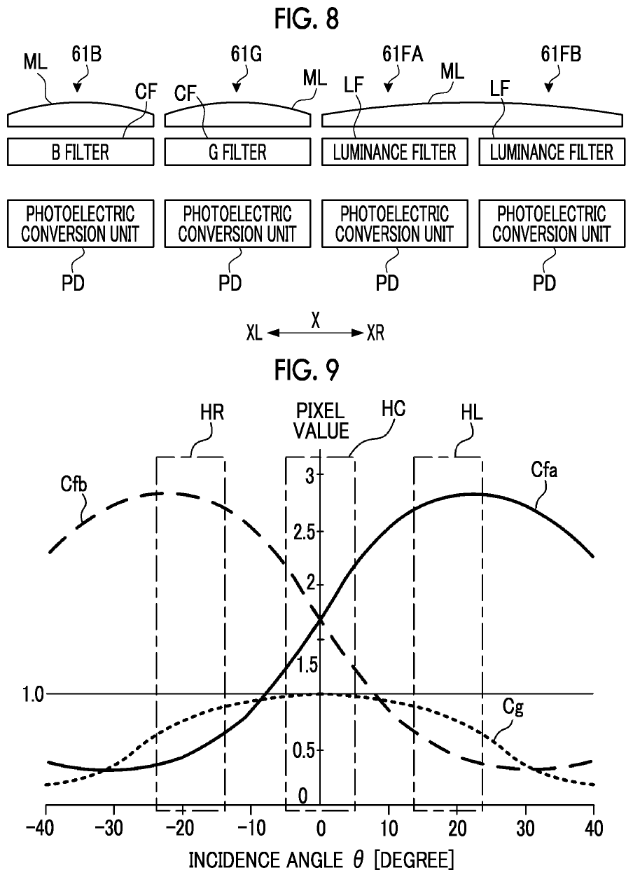

FIG. 8 is a diagram for describing a first modification example of the imaging element 5, and is a schematic cross-sectional view showing the range A2 of FIG. 4. The imaging element 5 of the modification example shown in FIG. 8 is the same as the above-described configuration except that the color filter CF included in each of the first phase difference detection pixel 61FA and the second phase difference detection pixel 61FB is changed to the luminance filter LF.

The luminance filter LF has spectral characteristics correlated with a brightness component of the light, and corresponds to a neutral density (ND) filter, a transparent filter, a white filter, a gray filter, or the like. In a configuration in which no member that hinders the transmission of the light is provided between the microlens ML and the photoelectric conversion unit PD and the light is directly incident on the photoelectric conversion unit, it can be said that the luminance filter LF is provided. The luminance filter LF can transmit light having a large number of wavelength components as compared with the color filter CF.

FIG. 9 is a diagram showing output characteristics of the pixel 61G, the first phase difference detection pixel 61FA, and the second phase difference detection pixel 61FB in the imaging element 5 of the modification example shown in FIG. 8. As shown in FIG. 9, the first phase difference detection pixel 61FA and the second phase difference detection pixel 61FB including the luminance filter LF have a larger sensitivity difference with the pixel 61G as compared with the case of FIG. 7. Therefore, in a case where the imaging element 5 having the output characteristics shown in FIG. 9 is used, the determination threshold value THC, the determination threshold value THR, and the determination threshold value THL are set to be larger than in the case of the output characteristics shown in FIG. 7.

In the imaging element 5 having the configuration shown in FIGS. 4 to 6, since the first phase difference detection pixel 61FA and the second phase difference detection pixel 61FB each include the G filter, the accuracy of determining whether or not the abnormal light incident on the first phase difference detection pixel 61FA and the second phase difference detection pixel 61FB is present is improved by using the pixel value of the pixel 61G including the same type of G filter.

On the other hand, in the imaging element 5 of the modification example shown in FIG. 8, the first phase difference detection pixel 61FA and the second phase difference detection pixel 61FB each include the luminance filter LF. Therefore, the accuracy of determining whether or not the abnormal light incident on the first phase difference detection pixel 61FA and the second phase difference detection pixel 61FB is present can be improved by using any of the pixel value of the pixel 61R including the R filter, the pixel value of the pixel 61G including the G filter, or the pixel value of the pixel 61B including the B filter.

For example, in a case of determining whether or not the abnormal light including a large amount of the red component is present, the determination accuracy can be improved by determining whether the abnormal light is present by using the pixel value of the pixel 61R including the R filter. In addition, in a case of determining whether or not the abnormal light including a large amount of the green component is present, the determination accuracy can be improved by determining whether the abnormal light is present by using the pixel value of the pixel 61G including the G filter. In a case of determining whether or not the abnormal light including a large amount of the blue component is present, the determination accuracy can be improved by determining whether the abnormal light is present using the pixel value of the pixel 61B including the B filter.

In a case where the pixel value of the pixel 61R is the largest among the pixel 61R, the pixel 61G, and the pixel 61B in the vicinity of the first phase difference detection pixel 61FA that is a determination target of the abnormal light, the abnormal light including a large amount of the red component is likely to be incident on the first phase difference detection pixel 61FA. Therefore, in this case, the system control unit 11 determines whether or not the abnormal light incident on the first phase difference detection pixel 61FA is present based on the pixel value of the first phase difference detection pixel 61FA and the pixel value of the pixel 61R in the vicinity of the first phase difference detection pixel 61FA.

In a case where the pixel value of the pixel 61G is the largest among the pixel 61R, the pixel 61G, and the pixel 61B in the vicinity of the first phase difference detection pixel 61FA that is a determination target of the abnormal light, the abnormal light including a large amount of the green component is likely to be incident on the first phase difference detection pixel 61FA. Therefore, in this case, the system control unit 11 determines whether or not the abnormal light incident on the first phase difference detection pixel 61FA is present based on the pixel value of the first phase difference detection pixel 61FA and the pixel value of the pixel 61G in the vicinity of the first phase difference detection pixel 61FA.

In a case where the pixel value of the pixel 61B is the largest among the pixel 61R, the pixel 61G, and the pixel 61B in the vicinity of the first phase difference detection pixel 61FA that is a determination target of the abnormal light, the abnormal light including a large amount of the blue component is likely to be incident on the first phase difference detection pixel 61FA. Therefore, in this case, the system control unit 11 determines whether or not the abnormal light incident on the first phase difference detection pixel 61FA is present based on the pixel value of the first phase difference detection pixel 61FA and the pixel value of the pixel 61B in the vicinity of the first phase difference detection pixel 61FA.

As described above, in a case where the determination of whether the abnormal light is present is performed by comparing the pixel values of the first phase difference detection pixel 61FA (second phase difference detection pixel 61FB) and the pixel 61 that detects a specific color in the vicinity of the first phase difference detection pixel 61FA (second phase difference detection pixel 61FB), it is preferable to determine the determination threshold value THC, the determination threshold value THR, and the determination threshold value THL for each detection color of the pixel 61. This is because the relationship between the output characteristics of the pixel 61R, the output characteristics of the pixel 61G, and the output characteristics of the pixel 61B with respect to the characteristic Cfb and the characteristic Cfa shown in FIG. 9 is not the same and may be different.

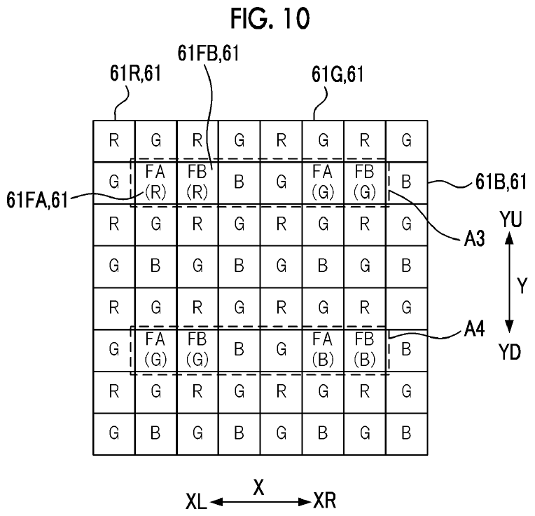

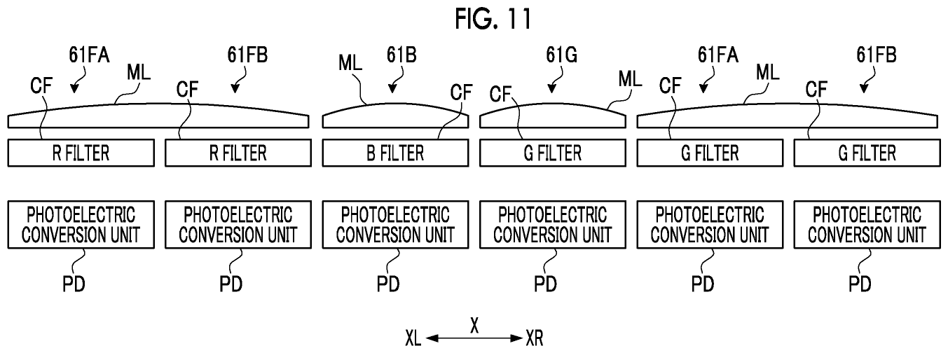

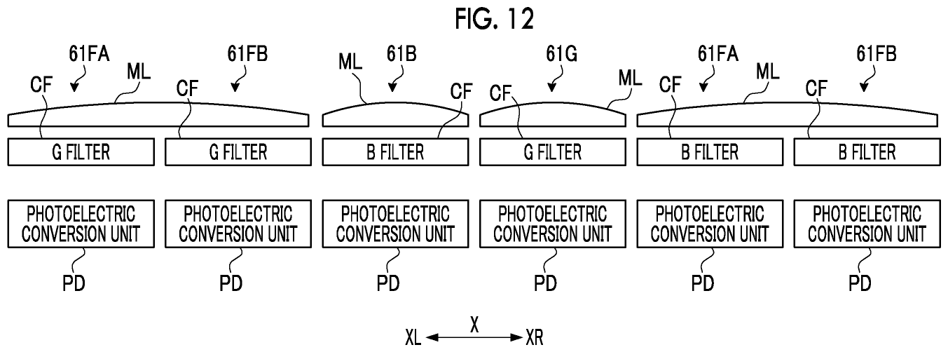

FIG. 10 is a diagram for describing a second modification example of the imaging element 5, and is a diagram corresponding to FIG. 4. FIG. 11 is a schematic cross-sectional view of a range A3 of FIG. 10. FIG. 12 is a schematic cross-sectional view of a range A4 of FIG. 10. The imaging element 5 of the modification example shown in FIG. 10 is different from FIG. 4 in that the imaging element 5 includes not only the phase difference detection pair including the G filter (referred to as (G) in FIG. 4) but also the phase difference detection pair including the R filter (referred to as (R) in FIG. 4) and the phase difference detection pair including the B filter (referred to as (B) in FIG. 4). That is, the imaging element 5 of the modification example shown in FIG. 10 has a configuration in which a plurality of types (three types in the example of FIG. 10) of phase difference detection pairs of the color filter CF and pixels 61 other than a plurality of types (three types in the example of FIG. 10) of phase difference detection pairs having different color filters CF are included.

In the digital camera 100 including the imaging element 5 shown in FIG. 10, the system control unit 11, for the first phase difference detection pixel 61FA (second phase difference detection pixel 61FB) including the R filter, determines whether the abnormal light is present by using the pixel value of the pixel 61R in the vicinity of the first phase difference detection pixel 61FA (second phase difference detection pixel 61FB). In addition, the system control unit 11 determines, for the first phase difference detection pixel 61FA (second phase difference detection pixel 61FB) including the G filter, whether the abnormal light is present by using the pixel value of the pixel 61G in the vicinity of the first phase difference detection pixel 61FA (second phase difference detection pixel 61FB). In addition, the system control unit 11 determines, for the first phase difference detection pixel 61FA (second phase difference detection pixel 61FB) including the B filter, whether the abnormal light is present by using the pixel value of the pixel 61B in the vicinity of the first phase difference detection pixel 61FA (second phase difference detection pixel 61FB). In this case as well, it is preferable to use the determination threshold value THC, the determination threshold value THR, and the determination threshold value THL corresponding to the detection color of the pixel 61 used for the determination.

According to the modification example shown in FIG. 10, it is possible to accurately determine whether or not the abnormal light including a large amount of the red component, the abnormal light including a large amount of the green component, and the abnormal light including a large amount of the blue component are present.

It should be noted that, for example, in a case where it is determined that the abnormal light is incident on the first phase difference detection pair including the color filter CF of the specific color, the system control unit 11 preferably detects the phase difference based on the pixel value of the remaining phase difference detection pair from which the first phase difference detection pair and the second phase difference detection pair around the first phase difference detection pair are excluded, and performs the focus detection process based on the phase difference. Even in a case where it is determined that there is no abnormal light in the second phase difference detection pixel around the first phase difference detection pair, a part of the abnormal light incident on the first phase difference detection pair may be incident on the second phase difference detection pair. Therefore, as described above, the phase difference can be detected with high accuracy by excluding the pixel value of the second phase difference detection pair from the phase difference calculation.

In the description so far, the system control unit 11 determines whether or not the abnormal light incident on the first phase difference detection pixel 61FA is present based on the comparison result between the pixel value of the first phase difference detection pixel 61FA and the pixel value of the pixel 61 other than the phase difference detection pair in the vicinity of the first phase difference detection pixel 61FA. In addition, the system control unit 11 determines whether or not the abnormal light incident on the second phase difference detection pixel 61FB is present based on the comparison result between the pixel value of the second phase difference detection pixel 61FB and the pixel value of the pixel 61 other than the phase difference detection pair in the vicinity of the second phase difference detection pixel 61FB.

In this modification example, the system control unit 11 may determine whether abnormal light is incident on the first phase difference detection pixel 61FA by using, in addition to a comparison result between a pixel value of the first phase difference detection pixel 61FA and a pixel value of a pixel 61 other than a phase difference detection pair and located in the vicinity of the first phase difference detection pixel 61FA, a comparison result between a pixel value of the first phase difference detection pixel 61FA and a pixel value of a second phase difference detection pixel 61FB that, together with the first phase difference detection pixel 61FA, constitutes a phase difference detection pair. In addition, the system control unit 11 may determine whether abnormal light is incident on the second phase difference detection pixel 61FB by using, in addition to a comparison result between a pixel value of the second phase difference detection pixel 61FB and a pixel value of a pixel 61 other than a phase difference detection pair and located in the vicinity of the second phase difference detection pixel 61FB, a comparison result between a pixel value of the second phase difference detection pixel 61FB and a pixel value of a first phase difference detection pixel 61FA that, together with the second phase difference detection pixel 61FB, constitutes a phase difference detection pair.

For example, as shown in FIG. 7, a large difference occurs between the pixel value of the first phase difference detection pixel 61FA and the pixel value of the second phase difference detection pixel 61FB for the abnormal light having a large absolute value of the incidence angle θ. Therefore, in the phase difference detection pair at the position where the light of the range HC in FIG. 7 is incident, in a case where the ratio of the pixel value of the first phase difference detection pixel 61FA to the pixel value of the pixel 61G is equal to or larger than the determination threshold value THC and the absolute value of the difference between the pixel value of the first phase difference detection pixel 61FA and the pixel value of the second phase difference detection pixel 61FB is equal to or larger than the threshold value, it is determined that the abnormal light incident on the first phase difference detection pixel 61FA is present. Similarly, in a case where the ratio of the pixel value of the second phase difference detection pixel 61FB to the pixel value of the pixel 61G is equal to or larger than the determination threshold value THC and the absolute value of the difference between the pixel value of the first phase difference detection pixel 61FA and the pixel value of the second phase difference detection pixel 61FB is equal to or larger than the threshold value, it is determined that the abnormal light is incident on the second phase difference detection pixel 61FB. In this way, it is possible to determine whether the abnormal light is present with higher accuracy.

In the description so far, the phase difference detection pair for detecting the phase difference in the row direction X is disposed on the imaging surface 60. The technology for determining whether the abnormal light is present, which has been described above, can be similarly applied to the imaging element 5 in which the phase difference detection pair for detecting the phase difference in the column direction Y is disposed on the imaging surface 60. In addition, the technology can be similarly applied to the imaging element 5 in which the phase difference detection pair for detecting the phase difference in the row direction X and the phase difference detection pair for detecting the phase difference in the column direction Y are disposed on the imaging surface 60.

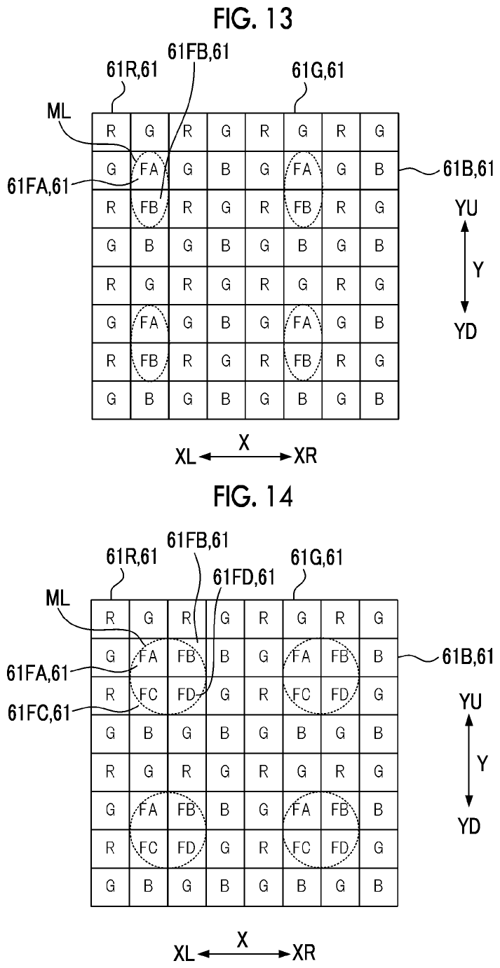

FIG. 13 is a diagram showing a third modification example of the imaging element 5, and is a diagram corresponding to FIG. 4. The imaging element 5 shown in FIG. 13 has a configuration in which, in the imaging element 5 shown in FIG. 4, the position of the second phase difference detection pixel 61FB that constitutes the phase difference detection pair is changed to a position adjacent to the first phase difference detection pixel 61FA that constitutes the phase difference detection pair in the downward direction YD, and the pixel 61G is disposed at a position where the original second phase difference detection pixel 61FB is disposed. In the example shown in FIG. 13, the microlens ML included in the phase difference detection pair has a major axis direction that matches the column direction Y.

Even in the configuration shown in FIG. 13, in a case where the incidence angle θ is defined by replacing the row direction X with the column direction Y in FIG. 3, the relationship between the phase difference detection pair and the output characteristics of the pixel 61G is the same as that shown in FIG. 7. Therefore, it is possible to determine whether or not the abnormal light incident on the first phase difference detection pixel 61FA is present based on the pixel value of the first phase difference detection pixel 61FA and the pixel value of the pixel 61G in the vicinity of the first phase difference detection pixel 61FA. In addition, it is possible to determine whether or not the abnormal light incident on the second phase difference detection pixel 61FB is present based on the pixel value of the second phase difference detection pixel 61FB and the pixel value of the pixel 61G in the vicinity of the second phase difference detection pixel 61FB.

FIG. 14 is a diagram showing a fourth modification example of the imaging element 5, and is a diagram corresponding to FIG. 4. The imaging element 5 shown in FIG. 14 has a configuration in which, in the imaging element 5 shown in FIG. 4, the pixel 61G and the pixel 61R adjacent to the phase difference detection pair in the downward direction YD are replaced with a third phase difference detection pixel 61FC and a fourth phase difference detection pixel 61FD.

In the imaging element 5 shown in FIG. 14, the microlens ML is shared by four pixels 61 of the first phase difference detection pixel 61FA, the second phase difference detection pixel 61FB, the third phase difference detection pixel 61FC, and the fourth phase difference detection pixel 61FD, and the phase difference detection group is configured by the four pixels 61. A plurality of group rows in which the phase difference detection groups are arranged in the row direction X are disposed in the column direction Y on the imaging surface 60. It can also be said that a plurality of group columns in which the phase difference detection groups are arranged in the column direction Y are disposed in the row direction X on the imaging surface 60.

The system control unit 11 derives a first average value of the pixel value of the first phase difference detection pixel 61FA and the pixel value of the third phase difference detection pixel 61FC in the phase difference detection group, and derives a second average value of the pixel value of the second phase difference detection pixel 61FB and the pixel value of the fourth phase difference detection pixel 61FD. The system control unit 11 performs a correlation operation between a group of the first average values and a group of the second average values derived for the phase difference detection groups of the same group row to detect the phase difference in the row direction X.

The system control unit 11 derives a third average value of the pixel value of the first phase difference detection pixel 61FA and the pixel value of the second phase difference detection pixel 61FB in the phase difference detection group, and derives a fourth average value of the pixel value of the third phase difference detection pixel 61FC and the pixel value of the fourth phase difference detection pixel 61FD. The system control unit 11 performs a correlation operation between a group of the third average values and a group of the fourth average values derived for the phase difference detection groups of the same group column to detect the phase difference in the column direction Y.

The change in the first average value with respect to the incidence angle θ is equivalent to the characteristic Cfa of FIG. 7. The change in the second average value with respect to the incidence angle θ is equivalent to the characteristic Cfb of FIG. 7. Therefore, it is possible to determine whether or not the abnormal light incident on the first phase difference detection pixel 61FA and the third phase difference detection pixel 61FC is present based on the first average value and the pixel value of the pixel 61G. In addition, it is possible to determine whether or not the abnormal light incident on the second phase difference detection pixel 61FB and the fourth phase difference detection pixel 61FD is present based on the second average value and the pixel value of the pixel 61G.

In addition, it is possible to determine whether or not the abnormal light incident on the first phase difference detection pixel 61FA and the second phase difference detection pixel 61FB is present based on the third average value and the pixel value of the pixel 61G. In addition, it is possible to determine whether or not the abnormal light incident on the third phase difference detection pixel 61FC and the fourth phase difference detection pixel 61FD is present based on the fourth average value and the pixel value of the pixel 61G.

Next, a configuration of a smartphone which is another embodiment of the imaging apparatus according to the present invention will be described.

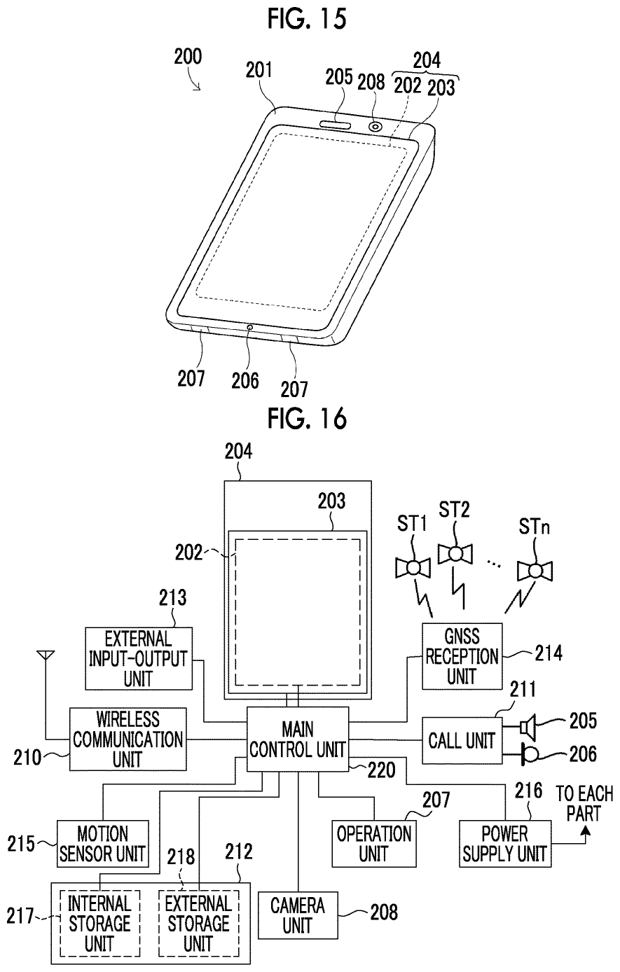

FIG. 15 is a diagram showing an exterior of the smartphone 200. The smartphone 200 shown in FIG. 15 includes a housing 201 having a flat plate shape and comprises a display and input unit 204 in which a display panel 202 as a display unit and an operation panel 203 as an input unit are integrated on one surface of the housing 201.

In addition, the housing 201 comprises a speaker 205, a microphone 206, an operation unit 207, and a camera unit 208. The configuration of the housing 201 is not limited thereto and, for example, a configuration in which the display unit and the input unit are independently disposed can be employed, or a configuration having a folded structure or a sliding mechanism can be employed.

FIG. 16 is a block diagram showing a configuration of the smartphone 200 shown in FIG. 15.

As shown in FIG. 16, the smartphone comprises, as main constituents, a wireless communication unit 210, the display and input unit 204, a call unit 211, the operation unit 207, the camera unit 208, a storage unit 212, an external input-output unit 213, a global navigation satellite system (GNSS) reception unit 214, a motion sensor unit 215, a power supply unit 216, and a main control unit 220.

In addition, the smartphone 200 comprises, as a main function, a wireless communication function of performing mobile wireless communication via a base station apparatus BS (not shown) and a mobile communication network NW (not shown).

The wireless communication unit 210 performs wireless communication with the base station apparatus BS accommodated in the mobile communication network NW in accordance with instructions from the main control unit 220. By using the wireless communication, transmission and reception of various file data such as audio data and image data, electronic mail data, or the like and reception of web data, streaming data, or the like are performed.

The display and input unit 204 is a so-called touch panel that visually delivers information to the user by displaying images (still images and video images), text information, or the like and that detects a user operation with respect to the displayed information under control of the main control unit 220. The display and input unit 204 comprises the display panel 202 and the operation panel 203.

The display panel 202 uses a liquid crystal display (LCD), an organic electro-luminescence display (OELD), or the like as a display device.

The operation panel 203 is a device that is placed such that an image displayed on a display surface of the display panel 202 can be visually recognized, and that detects one or a plurality of coordinates operated with a finger of the user or with a stylus. In a case where the device is operated with the finger of the user or with the stylus, a detection signal generated by the operation is output to the main control unit 220. Next, the main control unit 220 detects an operation position (coordinates) on the display panel 202 based on the received detection signal.

As shown in FIG. 16, although the display panel 202 and the operation panel 203 of the smartphone 200 shown as an embodiment of the imaging apparatus according to the present invention are integrated to constitute the display and input unit 204, the operation panel 203 is disposed to completely cover the display panel 202.

In a case where such disposition is employed, the operation panel 203 may comprise a function of detecting the user operation even in a region outside the display panel 202. In other words, the operation panel 203 may comprise a detection region (hereinafter, referred to as a display region) for an overlapping portion overlapping with the display panel 202 and a detection region (hereinafter, referred to as a non-display region) for an outer edge portion, other than the overlapping portion, that does not overlap with the display panel 202.

A size of the display region and a size of the display panel 202 may completely match, but both sizes do not need to match. In addition, the operation panel 203 may comprise two sensitive regions of the outer edge portion and an inner portion other than the outer edge portion. Furthermore, a width of the outer edge portion is appropriately designed depending on a size and the like of the housing 201.

Furthermore, examples of a position detection method employed in the operation panel 203 include a matrix switch method, a resistive membrane system, a surface acoustic wave method, an infrared method, an electromagnetic induction method, and a capacitance method, and any method can be employed.

The call unit 211 comprises the speaker 205 or the microphone 206, and converts voice of the user input through the microphone 206 into audio data processable in the main control unit 220 and outputs the audio data to the main control unit 220, or decodes audio data received by the wireless communication unit 210 or by the external input-output unit 213 and outputs the decoded audio data from the speaker 205.

In addition, as shown in FIG. 15, for example, the speaker 205 can be mounted on the same surface as a surface on which the display and input unit 204 is provided, and the microphone 206 can be mounted on a side surface of the housing 201.

The operation unit 207 is a hardware key that uses a key switch or the like, and receives instructions from the user. For example, as shown in FIG. 15, the operation unit 207 is a push button-type switch that is mounted on the side surface of the housing 201 of the smartphone 200, and is turned on by being pressed with the finger or the like and is set to an OFF state by a restoring force of a spring or the like in a case where the finger is released.

The storage unit 212 stores a control program and control data of the main control unit 220, application software, address data in which a name, a telephone number, or the like of a communication counterpart is associated, transmitted and received electronic mail data, web data downloaded by web browsing, and downloaded contents data, and temporarily stores streaming data or the like. In addition, the storage unit 212 is configured with an internal storage unit 217 incorporated in the smartphone and with an external storage unit 218 that has a slot for an attachable and detachable external memory.

Each of the internal storage unit 217 and the external storage unit 218 constituting the storage unit 212 is implemented using a storage medium such as a memory (for example, a MicroSD (registered trademark) memory) of a flash memory type, a hard disk type, a multimedia card micro type, or a card type, a random access memory (RAM), or a read only memory (ROM).

The external input-output unit 213 serves as an interface with all external apparatuses connected to the smartphone 200 and is directly or indirectly connected to other external apparatuses by communication or the like (for example, a universal serial bus (USB), IEEE1394, Bluetooth (registered trademark), radio frequency identification (RFID), infrared communication (Infrared Data Association (IrDA) (registered trademark)), Ultra Wideband (UWB) (registered trademark), or ZigBee (registered trademark)) or through a network (for example, Ethernet (registered trademark) or a wireless local area network (LAN)).

For example, the external apparatuses connected to the smartphone 200 include a wired/wireless headset, a wired/wireless external charger, a wired/wireless data port, a memory card and a subscriber identity module (SIM)/user identity module (UIM) card connected via a card socket, an external audio and video apparatus connected via an audio and video input/output (I/O) terminal, an external audio and video apparatus connected in a wireless manner, a smartphone connected in a wired/wireless manner, a personal computer connected in a wired/wireless manner, a personal computer connected in a wired/wireless manner, and an earphone.

The external input-output unit 213 can deliver data transferred from the external apparatuses to each constituent in the smartphone 200 or transfer data in the smartphone 200 to the external apparatuses.

The GNSS reception unit 214 receives GNSS signals transmitted from GNSS satellites ST1 to STn, executes positioning computation processing based on the received plurality of GNSS signals, and detects a position consisting of a latitude, a longitude, and an altitude of the smartphone 200 in accordance with instructions from the main control unit 220. In a case where positional information can be acquired from the wireless communication unit 210 or from the external input-output unit 213 (for example, a wireless LAN), the GNSS reception unit 214 can detect the position using the positional information.

The motion sensor unit 215 comprises, for example, a three-axis acceleration sensor and detects a physical motion of the smartphone 200 in accordance with instructions from the main control unit 220. By detecting the physical motion of the smartphone 200, a movement direction or acceleration of the smartphone 200 is detected. The detection result is output to the main control unit 220.

The power supply unit 216 supplies power stored in a battery (not shown) to each unit of the smartphone 200 in accordance with instructions from the main control unit 220.

The main control unit 220 comprises a microprocessor, operates in accordance with the control program and with the control data stored in the storage unit 212, and manages and controls each unit of the smartphone 200. The microprocessor of the main control unit 220 has the same function as the system control unit 11. In addition, the main control unit 220 comprises a mobile communication control function of controlling each unit of a communication system and an application processing function in order to perform voice communication or data communication through the wireless communication unit 210.

The application processing function is implemented by operating the main control unit 220 in accordance with the application software stored in the storage unit 212. For example, the application processing function is an infrared communication function of performing data communication with counter equipment by controlling the external input-output unit 213, an electronic mail function of transmitting and receiving electronic mails, or a web browsing function of viewing a web page.

In addition, the main control unit 220 comprises an image processing function such as displaying an image on the display and input unit 204 based on image data (data of a still image or of a video image) such as reception data or downloaded streaming data.

The image processing function refers to a function of causing the main control unit 220 to decode the image data, perform image processing on the decoding result, and display the image on the display and input unit 204.

Furthermore, the main control unit 220 executes a display control of the display panel 202 and an operation detection control of detecting user operations performed through the operation unit 207 and through the operation panel 203.

By executing the display control, the main control unit 220 displays an icon for starting the application software or a software key such as a scroll bar or displays a window for creating an electronic mail.

The scroll bar refers to a software key for receiving an instruction to move a display portion of an image, such as a large image that does not fit in the display region of the display panel 202.

In addition, by executing the operation detection control, the main control unit 220 detects the user operation performed through the operation unit 207, receives an operation with respect to the icon and an input of a text string in an input field of the window through the operation panel 203, or receives a request for scrolling the display image made through the scroll bar.

Furthermore, by executing the operation detection control, the main control unit 220 comprises a touch panel control function of determining whether the operation position on the operation panel 203 is in the overlapping portion (display region) overlapping with the display panel 202 or is in the outer edge portion (non-display region), other than the overlapping portion, not overlapping with the display panel 202 and of controlling the sensitive region of the operation panel 203 or a display position of the software key.

In addition, the main control unit 220 can detect a gesture operation with respect to the operation panel 203 and execute a function set in advance in accordance with the detected gesture operation.

The gesture operation is not a simple touch operation in the related art and means an operation of drawing a path with the finger or the like, designating a plurality of positions at the same time, or as a combination thereof, drawing a path from at least one of the plurality of positions.

The camera unit 208 includes the lens device 40, the imaging element 5, and the digital signal processing unit 17 shown in FIG. 1.

Captured image data generated by the camera unit 208 can be stored in the storage unit 212 or output through the external input-output unit 213 or through the wireless communication unit 210.

In the smartphone 200 shown in FIG. 16, the camera unit 208 is mounted on the same surface as the display and input unit 204. However, a mount position of the camera unit 208 is not limited thereto. The camera unit 208 may be mounted on a rear surface of the display and input unit 204.

In addition, the camera unit 208 can be used for various functions of the smartphone 200. For example, an image acquired by the camera unit 208 can be displayed on the display panel 202, or the image of the camera unit 208 can be used as one of operation inputs of the operation panel 203.

In addition, in a case where the GNSS reception unit 214 detects the position, the position can be detected by referring to the image from the camera unit 208. Furthermore, by referring to the image from the camera unit 208, it is possible to determine an optical axis direction of the camera unit 208 of the smartphone 200 or to determine the current use environment without using the three-axis acceleration sensor or by using the three-axis acceleration sensor in combination. Of course, the image from the camera unit 208 can also be used in the application software.

In addition, image data of a still image or of a video image to which the positional information acquired by the GNSS reception unit 214, voice information (may be text information acquired by performing voice to text conversion via the main control unit or the like) acquired by the microphone 206, posture information acquired by the motion sensor unit 215, or the like is added can be stored in the storage unit 212 or be output through the external input-output unit 213 or through the wireless communication unit 210.

Although various embodiments have been described above, it is needless to say that the present invention is not limited to such examples. It is apparent that those skilled in the art may perceive various modification examples or correction examples within the scope disclosed in the claims, and those examples are also understood as falling within the technical scope of the present invention. In addition, without departing from the gist of the invention, each of components in the embodiments may be combined in any manner.

The present application is based on Japanese Patent Application (JP2023-168348) filed on Sep. 28, 2023, the content of which is incorporated in the present application by reference.

### EXPLANATION OF REFERENCES

1: imaging lens
A1, A2, A3, A4: range
4: lens control unit
5: imaging element
8: lens drive unit
9: drive unit
11: system control unit
14, 207: operation unit
15: memory control unit
16: memory
17: digital signal processing unit
20: external memory control unit
21: storage medium
22: display device
22a: display controller
22b: display surface
24: control bus
25: data bus
40: lens device
60: imaging surface
61, 61B, 61G, 61R: pixel
61FA: first phase difference detection pixel
61FB: second phase difference detection pixel
61FC: third phase difference detection pixel
61FD: fourth phase difference detection pixel
62: pixel row
63: drive circuit
64: signal processing circuit
100: digital camera
100A: body part
200: smartphone
201: housing
202: display panel
203: operation panel
204: display and input unit
205: speaker
206: microphone
208: camera unit
210: wireless communication unit
211: call unit
212: storage unit
213: external input-output unit
214: GNSS reception unit
215: motion sensor unit
216: power supply unit
217: internal storage unit
218: external storage unit
220: main control unit

What is claimed is:

1. An information processing apparatus comprising:
an imaging element including a plurality of pixels each including a photoelectric conversion unit that converts light collected by a microlens into an electric charge, the plurality of pixels including first pixels in each of which the microlens is shared with an adjacent pixel and second pixels each of which is a pixel that has the microlens that is not shared with an adjacent pixel, wherein the microlens that collects light onto the first pixel and the adjacent pixel has a larger planar shape than the microlens that collects light only onto the second pixel; and
a processor that is configured to determine, based on a ratio or a difference between a first pixel value of one of the first pixels and a second pixel value of one of the second pixels, whether abnormal light incident on the one of the first pixels is present.

2. The information processing apparatus according to claim 1,
wherein the processor is configured to determine, based on the ratio or the difference and a threshold value, whether the abnormal light is present.

3. The information processing apparatus according to claim 2,
wherein the processor is configured to determine that the abnormal light is present in a case where the ratio or the difference is equal to or larger than the threshold value.

4. The information processing apparatus according to claim 2,
wherein the processor is configured to control the threshold value.

5. The information processing apparatus according to claim 4,
wherein the processor is configured to change the threshold value based on a position of the one of the first pixels that is a target for determining whether the abnormal light is present.

6. The information processing apparatus according to claim 4,
wherein the processor is configured to change the threshold value based on a condition of an imaging optical system disposed between the imaging element and a subject.

7. The information processing apparatus according to claim 6,
wherein the condition includes at least one of an F number of a stop included in the imaging optical system or a focal length of the imaging optical system.

8. The information processing apparatus according to claims 1,
wherein each of the first pixels includes a luminance filter,
each of the second pixels includes a color filter,
the plurality of pixels include a plurality of types of the second pixels having different types of the color filter, and
the processor is configured to determine, based on the first pixel value of the one of the first pixels and the second pixel value of one of the plurality of types of the second pixels, whether the abnormal light incident on the one of the first pixels is present.

9. The information processing apparatus according to claim 1,
wherein each of the first pixels includes a color filter and each of the second pixels includes a color filter,
the plurality of pixels include a plurality of types of the first pixels having different types of the color filter and a plurality of types of the second pixels having different types of the color filter, and
the processor is configured to determine, based on the first pixel value of the one of the first pixels including a first type of the color filter and the second pixel value of the one of the second pixels including the first type of the color filter, whether the abnormal light incident on the one of the first pixels is present.

10. The information processing apparatus according to claim 1,
wherein the processor is configured to perform a focus detection process based on a pixel value of at least one of the first pixels.

11. The information processing apparatus according to claim 10,
wherein the processor is configured to perform, in a case where the processor has determined that the first pixel on which the abnormal light is incident is present, the focus detection process based on pixel values of the first pixels excluding at least the first pixel on which the abnormal light is incident.

12. The information processing apparatus according to claim 11,
wherein the processor is configured to perform, in a case where the processor has determined that the first pixel on which the abnormal light is incident is present, the focus detection process based on pixel values of the first pixels excluding the first pixel on which the abnormal light is incident and the first pixels around the first pixel on which the abnormal light is incident.

13. The information processing apparatus according to claim 1,
wherein the processor is configured to further use a comparison result of pixel values of a plurality of the first pixels that include a plurality of the photoelectric conversion units that share the microlens to determine whether the abnormal light is present.

14. The information processing apparatus according to claim 1,
wherein the first pixels are pixels in which the microlens is shared between two adjacent first pixels.

15. An imaging apparatus comprising:
the information processing apparatus according to claim 1; and
the imaging element.

16. An information processing method for processing an output of an imaging element including a plurality of pixels each including a photoelectric conversion unit that converts light collected by a microlens into an electric charge, the plurality of pixels including first pixels in each of which the microlens is shared with an adjacent pixel and second pixels each of which is a pixel that has the microlens that is not shared with an adjacent pixel,
wherein the microlens that collects light onto the first pixel and the adjacent pixel has a larger planar shape than the microlens that collects light only onto the second pixel, and
the information processing method comprises:
determining, based on a ratio or a difference between a first pixel value of one of the first pixels and a second pixel value of one of the second pixels, whether abnormal light incident on the one of the first pixels is present.

17. A non-transitory computer readable medium storing a information processing program for processing an output of an imaging element including a plurality of pixels each including a photoelectric conversion unit that converts light collected by a microlens into an electric charge, the plurality of pixels including first pixels in each of which the microlens is shared with an adjacent pixel and second pixels each of which is a pixel that has the microlens that is not shared with an adjacent pixel,
wherein the microlens that collects light onto the first pixel and the adjacent pixel has a larger planar shape than the microlens that collects light only onto the second pixel, and
the information processing program causes a processor to execute:
determining, based on a ratio or a difference between a first pixel value of one of the first pixels and a second pixel value of one of the second pixels, whether abnormal light incident on the one of the first pixels is present.
